(19) United States
(12) Patent Application Publication
(10) Pub. No.: US 2024/0154492 A1
(43) Pub. Date: May 9, 2024

(54) ELECTRIC MOTOR HAVING A STATOR HOUSING

(71) Applicant: SEW-EURODRIVE GMBH & CO. KG, Bruchsal (DE)

(72) Inventors: Jochen RIESER, Karlsruhe (DE); Johannes BRÖDNER, Ubstadt-Weiher (DE)

(73) Assignee: SEW-EURODRIVE GMBH & CO. KG, Bruchsal (DE)

(21) Appl. No.: 18/549,289

(22) PCT Filed: Feb. 9, 2022
(86) PCT No.: PCT/EP2022/053174

§ 371 Date: Sep. 6, 2023

(30) Foreign Application Priority Data
Mar. 9, 2021 (DE) 102021001252.6

(51) Int. Cl. H02K 5/22; H02K 5/02; H02K 5/10; H02K 5/173; H02K 11/21

(52) U.S. Cl. CPC H02K 5/225; H02K 5/02; H02K 5/10; H02K 5/1732; H02K 11/21

(57) ABSTRACT

An electric motor includes a stator housing arranged as a composite part and/or having a tubular part onto which a tube is fitted, the tubular part being force-locked to the tube.

### FIELD OF THE INVENTION

The present invention relates to an electric motor having a stator housing.

### BACKGROUND INFORMATION

In certain conventional systems, a housing of an electric motor is made of a material that has an intended chemical property, e.g., for use of the electric motor in an application with specified chemical requirements.

An electric motor is described in German Patent Document No. 10 2014 001 267.

A motor part is described in German Patent Document No. 100 39 074.

An electric motor assembly unit is described in PCT Patent Document No. WO 2020/109897.

### SUMMARY

Example embodiments of the present invention provide an electric motor that is usable in an environment with specified chemical requirements and is implementable as compact as possible.

According to example embodiments, an electric motor includes a stator housing that is implemented as a composite part formed from a radially inner part and a radially outer part with respect thereto, and/or a stator housing that has a tubular part onto which a tube is placed, in which tubular part is force-locked to the tube.

Thus, the motor can be implemented as compact as possible and can still be compatible with a desired chemical requirement, e.g., can be implemented with as low a mass as possible, as efficient a heat dissipation as possible, and still with an outer surface that fulfills the chemical requirements, e.g., is chemically stable.

This is because the stator housing, which is formed as a composite part and/or from the tube and the tubular part, is formed from a radially inner part and a radially outer part with respect thereto. Thus, the outer part, e.g., the tube, has the desired chemical property but can be implemented with very thin walls so that the mechanical and heat conduction properties are fulfilled by the inner part, e.g., the tubular part. The inner part can be implemented using a material with good heat conductivity, which quickly spreads the heat of the stator and dissipates it to the housing parts arranged axially on both sides, e.g., to a bearing flange and a housing part. Although the housing part and the bearing flange each accommodate a bearing of the rotor shaft and must therefore also absorb heat from the bearing and dissipate it to the environment, the housing part and the bearing flange have a large heat capacity and can therefore absorb the heat flows of both heat sources and dissipate them to the environment without any significant temperature increases.

According to example embodiments, the tube is implemented using a first material, and the tubular part is implemented using a second material. The density of the first material is greater than the density of the second material. For example, the density of the first material is twice or more than twice the density of the second material. Thus, the different material properties can be used radially inside and outside.

According to example embodiments, the first material is a metal and the second material is a metal. For example, the specific heat conductivity of the second material is greater, e.g., more than twice, the specific heat conductivity of the first material. Thus, depending on the material, the heat conductivity is high or very high.

According to example embodiments, the tube is made of steel, e.g., stainless steel, and the tubular part is made of a light metal, e.g., aluminum. Thus, a chemically stable surface can be provided facing the environment and the light metal can be used internally to dissipate heat efficiently and save mass.

According to example embodiments, the tubular part is heat-bonded to the tube. Thus, the stator housing can be manufactured as a composite part.

According to example embodiments, during production of the stator housing before and/or during fitting the tube onto the tubular part, there is a temperature difference, e.g., of more than 40 Kelvin, more than 150 Kelvin, etc., between the tube and the tubular part. Thus, the force-locked connection has a high load-bearing capacity and the stator housing can be implemented as a load-bearing composite part which is compact and can be implemented with little mass, and it nevertheless has a stable chemical surface facing the environment, e.g., a stainless steel surface.

According to example embodiments, a rotor shaft of the electric motor is rotatably supported by a first bearing accommodated in a bearing flange of the electric motor and by a second bearing accommodated in a housing part, e.g., relative to the stator housing. Thus, the tubular part can be placed between the bearing flange and the housing part.

According to example embodiments, the tube, the bearing flange, and the housing part include and/or are made of the first material, e.g., stainless steel. Thus, apart from the material of the seals, the electric motor has only the first material facing the environment.

According to example embodiments, at least one tensioning device presses the bearing flange and the housing part onto the tubular part, and the tubular part is arranged between the bearing flange and the housing part. Thus, the tubular part can be clamped between the bearing flange and the housing part by the tensioning.

According to example embodiments, the tubular part is inserted into the bearing flange, e.g., partially inserted, inserted into a cylindrical cutout of the bearing flange, etc. Thus, the tubular part can be centered in the bearing flange and can be accommodated safely and securely.

According to example embodiments, the tubular part is inserted into the housing part, e.g., partially inserted, inserted into a cylindrical cutout of the housing part. Thus, the tubular part can be centered in the housing part and can be accommodated safely and securely.

According to example embodiments, a seal, e.g., an O-ring, is fitted onto the tubular part, which seals the tube from the housing part. For example, the seal is accommodated in an annular groove of the tubular part, and the seal is axially interposed between the tube and the housing part. Thus, the tube is sealed from the housing part and also from a or the bearing flange, and the outer surface of the motor includes only the material of the bearing flange, the housing part, and the tube, and additionally of the material of the seal, e.g., this material is similar to the material of a shaft sealing ring accommodated in the bearing flange, which seals the bearing flange from the rotor shaft. Where applicable, the outwardly protruding area of the rotor shaft also counts as part of the outer surface. The O-ring, which can be accommodated via an annular groove, is positioned by the annular groove, which also allows the tube to be positioned axially.

According to example embodiments, a further seal, e.g., an O-ring, is fitted onto the tubular part, which seals the tube from the bearing flange, e.g., from the environment. For example, the seal is accommodated in an annular groove of the tubular part, and the seal is axially interposed between the tube and the bearing flange. Thus, a high level of tightness, i.e., a high level of protection, can be achieved. In addition, the seal is snapped into an annular groove so that the seal is positioned axially.

According to example embodiments, the axial area covered by the tubular part in the axial direction, i.e., for example, parallel to the direction of the axis of rotation of the rotor shaft, overlaps with the area covered by the housing part in the axial direction, and area covered by the tube in the axial direction is spaced from the area covered by the housing part in the axial direction.

According to example embodiments, the axial area covered by the tubular part in the axial direction, i.e., for example, parallel to the direction of the axis of rotation of the rotor shaft, overlaps with the area covered by the bearing flange in the axial direction, and the area covered by the tube in the axial direction is spaced from the area covered by the bearing flange in the axial direction. The tubular part can be inserted into the bearing flange and can be centered by it.

According to example embodiments, a cover is placed on the housing part at its end region facing away from the tubular part, so that a connection area is surrounded by the cover and housing part to form a housing. For example, a connection device in the connection area for connecting lines of a supply cable, which is led into the connection area through a cable bushing, e.g., a cable gland, of the cover, to stator winding lines, e.g., to the stator winding wire, e.g., the stator winding. Thus, the housing part accommodates not only a bearing, but also the connection device for establishing the electrical supply to the stator winding of the electric motor.

According to example embodiments, a sensor for detecting the angular position of the rotor shaft is arranged at the axial end region of the rotor shaft, the sensor housing of which protrudes into the connection area. Thus, the sensor can be arranged within the connection area protected by the cover part and the housing part and is thus not exposed to the external environment and its chemical requirements.

According to example embodiments, the respective tensioning device protrudes through a respective axially continuous recess arranged in the tubular part. Thus, the tensioning device(s) are arranged in a protected manner and a cost-effective and compact connection can thus be achieved.

According to example embodiments, the tensioning device is implemented as a long screw screwed into a respective threaded bore of the bearing flange, which has a screw head at its first axial end region and an external thread at its other axial end region, or as a tension rod with screwed-on nuts or as a long screw with a screwed-on nut. Thus, a low-cost and compact connection can be achieved.

Further features and aspects of example embodiments of the present invention are explained in more detail below with reference to the appended schematic Figures.

### BRIEF DESCRIPTION OF THE DRAWINGS

FIG. 1 is a perspective view of an electric motor according to an example embodiment of the present invention.

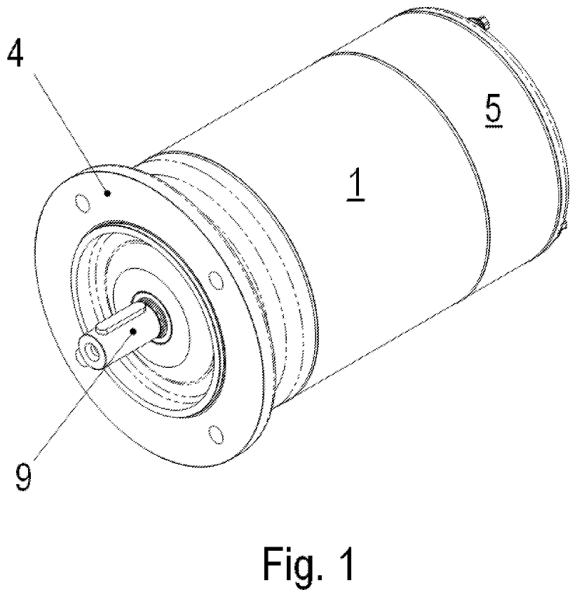

FIG. 2 is a longitudinal cross-sectional view along a first cross-sectional plane through the electric motor.

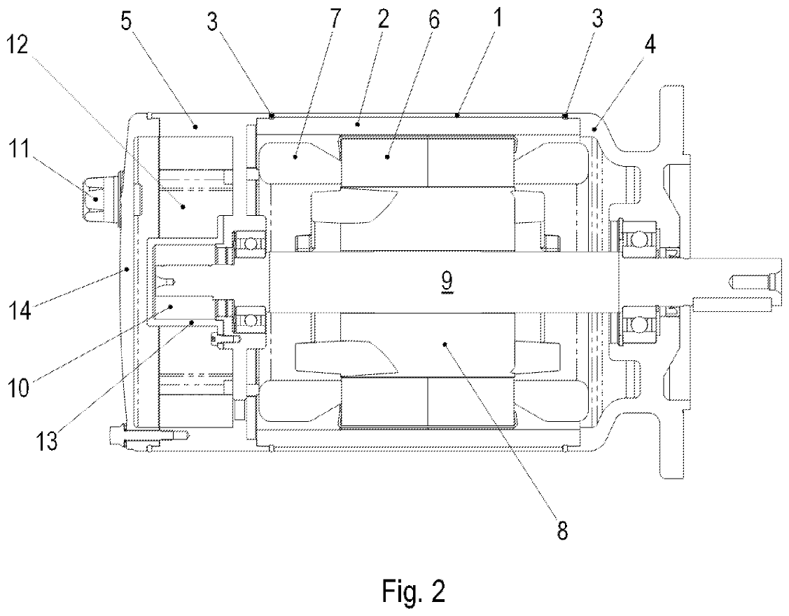

FIG. 3 is a longitudinal cross-sectional view along a second cross-sectional plane through the electric motor.

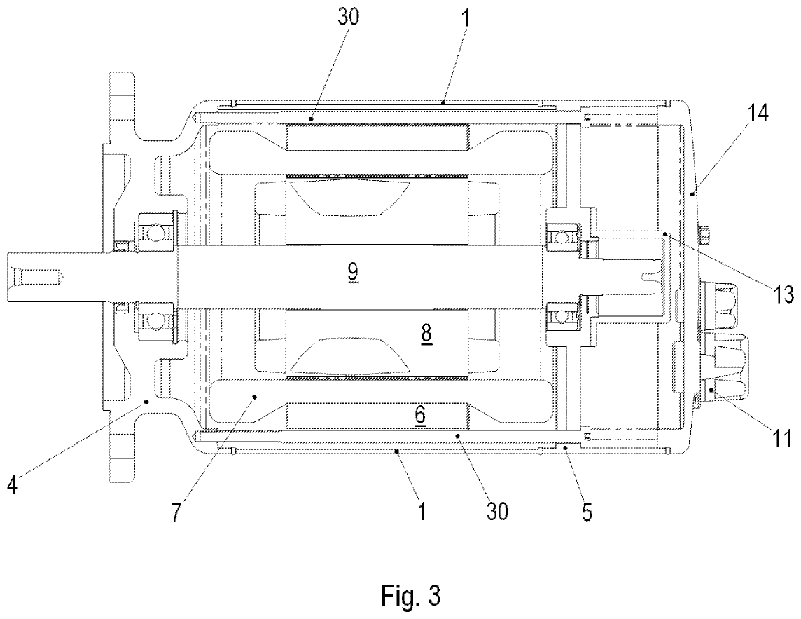

FIG. 4 is a perspective, cross-sectional view the electric motor.

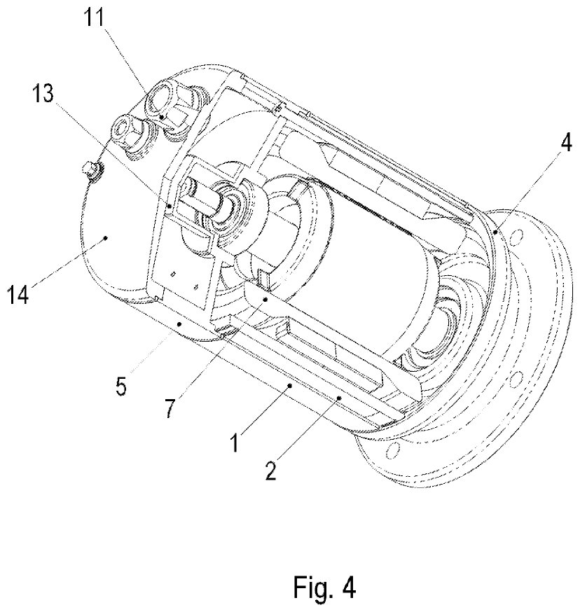

FIG. 5 is a perspective, cross-sectional view of the stator of the electric motor.

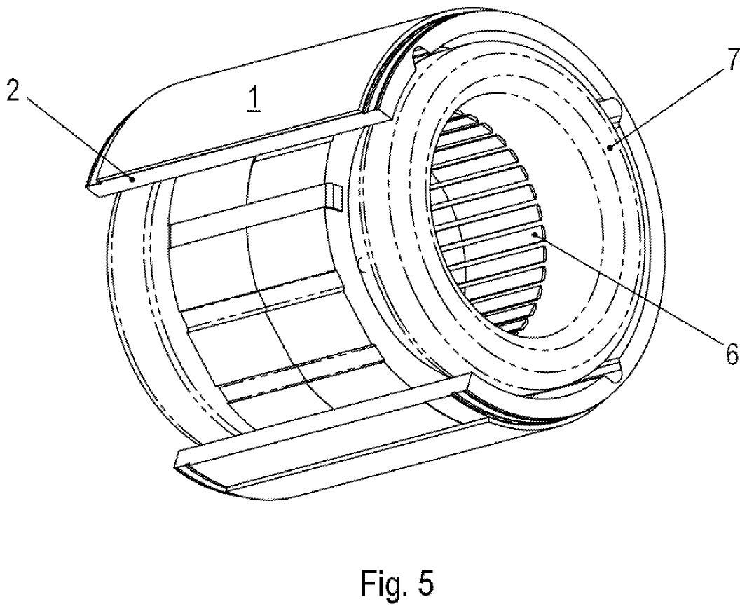

### DETAILED DESCRIPTION

As illustrated in the Figures, the stator of the electric motor is accommodated in a tubular part 2, e.g., an aluminum tube. The tubular part 2 is arranged between a bearing flange 4 and a housing part 5.

Tensioning devices 30, e.g., long screws or tension rods, spaced regularly from one another in the circumferential direction with respect to the axis of rotation of the rotor shaft 9 of the electric motor, press the housing part 5 and the bearing flange 4 onto the tubular part 2 so that a stable motor housing is formed.

The rotor shaft 9 is rotatably supported by a first bearing accommodated in the bearing flange 4 and by a second bearing accommodated in the housing part 5.

An active part 8 is connected to the rotor shaft 9 in a rotationally fixed manner, e.g., in force-locked manner.

A connection area 12 is also formed in the housing part 5, in which supply lines, which coming from the external environment are led through a cable gland 11 into the connection area 12, are connected to connection devices, which are each connected to stator winding wire for supplying the stator winding 7, which is provided on a laminated stator core 6, e.g., is provided wrapped around a laminated stator core 6.

The rotor shaft 9 protrudes with its first axial end region through the first bearing toward the external environment, so that a load to be driven can be connected, e.g., a gearbox. The other axial end region of the rotor shaft 9 protrudes into an angle sensor, which is suitably implemented to detect the angular position of the rotor shaft 9 and has a sensor housing 13, which is connected to the housing part 5. The engine interior is thus sealed from the connection area 12. A shaft seal ring accommodated in the bearing flange 4 seals the first axial end region of the rotor shaft 9 from the environment.

The active part 8, for example, has a short-circuit cage so that the electric motor is implemented as an asynchronous motor. For this purpose, the stator winding is implemented as a three-phase winding.

The connection area 12 is delimited by a cover 14 placed on the housing part 5 and the housing part 5 itself.

The cable gland is arranged on the cover 14.

The angle sensor has a first part, which is connected to the rotor shaft 9 in a rotationally fixed manner, and a second part, which is connected to the sensor housing 10. The second part is implemented as a sensor which is in active connection with, e.g., detects, the first part, which is implemented as a transducer.

An outer tube 1, e.g., a steel tube, a stainless steel tube, etc., is slid onto the tubular part 2, e.g., an aluminum tube, and connected in force-locked manner. For example, during production of the motor before the fitting, the tubular part 2 and the tube 1 have a temperature difference, e.g., of more than 40 Kelvin, more than 150 Kelvin, etc. Thus, the tube 1 is in close contact with the tubular part 2 and, together with the tubular part 2, forms a composite part acting as a stator housing.

The composite part thus, for example, has steel on its radially outer side and aluminum on its radially inner side.

A seal 3, e.g., an O-ring, is arranged between the tube 1 and the bearing flange 4. This seal is also slid onto the tubular part 2. For example, the tubular part 2 has an annular groove extending continuously in the circumferential direction on its radial outer side, in which groove the seal is accommodated and can thus be positioned axially. The seal 3 positions the tube 1.

A further seal 3, e.g., an O-ring, is arranged between the tube 1 and the housing part 5. This further seal 3 is also slid onto the tubular part 2. For example, the tubular part 2 has a further annular groove extending continuously in the circumferential direction on its radial outer side, in which groove the further seal 3 is accommodated and can thus be positioned axially. The further seal 3 positions the tube 1 in the axial direction with respect to the tubular part 2.

When the tensioning devices 30 are tightened, the bearing flange 4 presses the seal 3 onto the tube 1 and the housing part 5 presses the other seal 3 onto the tube 1. However, this compressing of the seals is limited in that the tubular part 2 rests against the bearing flange 4 and also against the housing part 5.

Thus, due to their elastic deformation, only a small axially directed first force is generated by the seals 3, which acts on the tube 1. The axially directed second force generated by the tensioning devices 30 and introduced into the tubular part 2 is much greater in magnitude, e.g., at least ten times greater, than the first force.

The tensioning devices 30 are guided through cutouts in the tubular part 2. The cutouts are implemented as axial bores in the tubular part 2, so that the outer radial edge of the tubular part 2 is cylindrically shaped and the tensioning devices 30 are surrounded by material all around, and, in addition, the rigidity of the tubular part 2 is very high. Alternatively, the cutouts can also be implemented as recesses, e.g., axial grooves open radially outwardly, so that assembly is made possible by inserting the tensioning devices 30 coming from the radial direction.

The tubular part 2 can, for example, be produced as a continuous casting profile part, e.g., as an aluminum continuous casting profile part.

The tensioning devices 30 are implemented either as a long screw with a screwed-on nut or as a tension rod with screwed-on nuts. In each case, the respective nut is in contact with the side of the bearing flange 4 facing away from the tubular part 2 or with the side of the housing part 5 facing away from the tubular part 2.

The laminated stator core includes a stack of individual laminations, which is, for example, connected by at least one clamp and/or punch-packetization, and force-locked into the tubular part 2, e.g., the stator housing.

The radial wall thickness of the tubular part 1 is smaller, e.g., at least four times smaller, than the radial wall thickness of the tubular part 2. Thus, high stiffness can be achieved with low mass of the composite part. In addition, the tube 1 can be implemented using steel, e.g., stainless steel, so that the housing part 5, which can also be implemented using stainless steel, and the bearing flange, which can also be implemented using stainless steel, result in a chemically uniform outer surface of the electric motor. Additionally, the rotor shaft 9 can also be implemented using stainless steel.

Thus, the electric motor has only stainless steel or sealing material on its entire surface. Thus, the electric motor can be used in an appropriate environment.

The stator housing is thus implemented as a tubular composite part, and the density of the material of the composite part is lower, e.g., at least twice lower, on its inner side than the density of its material on its outer side.

According to example embodiments, no angle sensor is provided instead of the angle sensor, so that the sensor housing 13 acts only as a cover for the axial shaft end of the rotor shaft 9.

### LIST OF REFERENCE NUMERALS

1 Outer tube, e.g., steel tube, stainless steel tube, etc.
2 Tubular part, e.g., aluminum tube
3 Sealing ring, e.g., O-ring
4 Bearing flange
5 Housing part
6 Laminated stator core
7 Stator winding
8 Active part, e.g., short-circuit cage
9 Rotor shaft
10 Angle sensor
11 Cable gland
12 Connection area
13 Sensor housing
14 Cover
30 Tensioning device, e.g., long screw or tension rod

1-17. (canceled)

18. An electric motor, comprising:
a stator housing;
wherein (a) the stator housing is arranged as a composite part and/or (b) the stator housing includes a tubular part arranged inside and force-locked to a tube.

19. The electric motor according to claim 18, wherein a radial outer side of the composite part is arranged as a tube and a radially inner side of the composite part is arranged as a tubular part.

20. The electric motor according to claim 19, wherein the tube is formed of steel and the tubular part is formed of aluminum.

21. The electric motor according to claim 18, wherein the tube is formed of a first material, the tubular part is formed of a second material, and a density of the first material is greater than a density of the second material.

22. The electric motor according to claim 21, wherein the density of the first material is at least twice the density of the second material.

23. The electric motor according to claim 21, wherein the first material includes a metal and the second material includes a metal.

24. The electric motor according to claim 21, wherein a specific heat conductivity of the second material is greater and/or more than twice a specific heat conductivity of the first material.

25. The electric motor according to claim 18, wherein the tube is formed of steel and/or stainless steel, and the tubular part is made of a light metal and/or aluminum.

26. The electric motor according to claim 18, wherein the tubular part is heat-bonded to the tube.

27. The electric motor according to claim 18, wherein, during production of the stator housing before and/or during fitting the tube onto the tubular part, there is a temperature difference, a temperature difference of more than 40 Kelvin, and/or a temperature difference of more than 150 Kelvin between the tube and the tubular part.

28. The electric motor according to claim 18, wherein a rotor shaft of the electric motor is rotatably supported by a first bearing accommodated in a bearing flange of the electric motor and by a second bearing accommodated in a housing part.

29. The electric motor according to claim 28, wherein the tube, the bearing flange, and the housing part consist of and/or are made of stainless steel.

30. The electric motor according to claim 28, wherein the tubular part is arranged in the bearing flange, partially arranged in the bearing flange, and/or arranged in a cylindrical cutout of the bearing flange.

31. The electric motor according to claim 28, wherein the tubular part is arranged in the housing part, partially arranged in the housing part, and/or arranged in a cylindrical cutout of the housing part.

32. The electric motor according to claim 28, wherein a tensioning device presses the bearing flange and the housing part onto the tubular part, and the tubular part is arranged between the bearing flange and the housing part.

33. The electric motor according to claim 28, wherein a seal and/or an O-ring is arranged on the tubular part and seals the tube from the housing part and/or from the environment.

34. The electric motor according to claim 33, wherein the seal is arranged in an annular groove of the tubular part.

35. The electric motor according to claim 33, wherein the seal is axially interposed between the tube and the housing part.

36. The electric motor according to claim 33, wherein a further seal and/or O-ring is arranged on the tubular part and seals the tube from the bearing flange and/or from the environment.

37. The electric motor according to claim 36, wherein the further seal is arranged in an annular groove of the tubular part.

38. The electric motor according to claim 36, wherein the further seal is axially interposed between the tube and the bearing flange.

39. The electric motor according to claim 28, wherein an axial area covered by the tubular part in an axial direction overlaps with an area covered by the housing part in the axial direction, and an area covered by the tube in the axial direction is spaced from an area covered by the housing part in the axial direction.

40. The electric motor according to claim 28, wherein an axial area covered by the tubular part in an axial direction overlaps with an area covered by the bearing flange in the axial direction, and an area covered by the tube in the axial direction is spaced from an area covered by the bearing flange in the axial direction.

41. The electric motor according to claim 28, wherein a cover is arranged on the housing part at an end region facing away from the tubular part, so that a connection area is surrounded by the cover and the housing part to form a housing.

42. The electric motor according to claim 41, wherein a connection device is arranged in the connection area to connect lines of a supply cable led into the connection area through a cable bushing and/or a cable gland of the cover to stator winding lines, a stator winding wire, and/or a stator winding.

43. The electric motor according to claim 41, wherein a sensor adapted to detect an angular position of the rotor shaft is arranged at an axial end region of the rotor shaft, a sensor housing of the housing protruding into the connection area.

44. The electric motor according to claim 32, wherein the tensioning device protrudes through an axially continuous recess arranged in the tubular part.

45. The electric motor according to claim 32, wherein the tensioning includes an elongated screw screwed into a threaded bore of the bearing flange and having a screw head at a first axial end region and an external thread at a second axial end region, includes a tension rod with screwed-on nuts, and/or includes an elongated long screw with a screwed-on nut.
